(19) United States
(12) Patent Application Publication
(10) Pub. No.: US 2015/0081741 A1
(43) Pub. Date: Mar. 19, 2015

(54) INCREMENTAL GRAPH VIEW MAINTENANCE

(71) Applicant: GraphSQL, Inc., Mountain View, CA (US)

(72) Inventor: Yu Xu, Millbrae, CA (US)

(21) Appl. No.: 14/486,259

(22) Filed: Sep. 15, 2014

Related U.S. Application Data
(60) Provisional application No. 61/878,244, filed on Sep. 16, 2013.

(51) Int. Cl. G06F 17/30

(52) U.S. Cl. CPC G06F 17/30958; G06F 17/30595
USPC 707/798

(57) ABSTRACT

Enclosed herein are systems, methods, and software to facilitate incremental graph view maintenance in a data system. In one example, a method of operating a graph maintenance module to implement graph view maintenance on a graph view based on a relational database includes identifying a modification to the relational database. The method further includes, identifying a graph modification for the graph view based on the modification to the relational database, and implementing the graph modification in the graph view.

### RELATED APPLICATIONS

This application is related to and claims priority to U.S. Provisional Patent Application No. 61/878,244, entitled “INCREMENTAL GRAPH VIEW MAINTENANCE,” filed on Sep. 16, 2013, and which is hereby incorporated by reference in its entirety.

### TECHNICAL FIELD

Aspects of the disclosure are related to graph views of relational databases, and in particular to providing incremental graph view maintenance.

### TECHNICAL BACKGROUND

A relational database system is a collection of data items organized as a set of formally described tables from which data can be accessed. These relational databases can become overwhelming, and the response to any query of these databases may require accessing of multitude of tables, each of which may be partially responsive to the query. Many relational databases, such as in social networks, grow rapidly as data changes with respect to participants and their various natures, features, qualities, and the like. Such a network may be represented by a massive graph, where nodes are connected by edges to other nodes, and both the nodes and edges represent associated relational data. For example, a user may be connected in a graph to other users based on like interests, location, profession, or any other information.

Previously, the updating and searching of these graphs has been laborious, time consuming, and inordinately and exhaustively detailed, requiring the individual treatment and assessment of each of a multiplicity of nodes and edges. Further, a graph may have to be regenerated to answer queries each time the tables are revised requiring resources and time that may have been better suited elsewhere.

### OVERVIEW

Examples disclosed herein provide systems, methods, and software for facilitating incremental graph view maintenance. In one example, a method of operating a graph maintenance module to implement graph view maintenance on a graph view based on a relational database includes identifying a modification to the relational database. The method further includes, identifying a graph modification for the graph view based on the modification to the relational database, and implementing the graph modification in the graph view.

In another instance, a computer apparatus to implement incremental graph view maintenance on a graph view includes processing instructions that direct a computing system to identify a modification to the relational database. The processing instructions further direct the computing system to identify a graph modification for the graph view based on the modification to the relational database, and implement the graph modification in the graph view. The computer apparatus also includes one or more non-transitory computer readable media that store the processing instructions.

In a further example, a data system includes a relational database configured to store data and relationship information about the data. The system further includes a graph database configured to store one or more graph views related to the relational database. The system also comprises a graph maintenance module configured to identify a modification to the relational database. The graph maintenance module is further configured to identify a graph modification for at least one graph view in the graph database based on the modification to the relational database, and implement the graph modification in the at least one graph view.

### BRIEF DESCRIPTION OF THE DRAWINGS

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

FIG. 1 illustrates an overview of implementing graph view maintenance.

FIG. 2 illustrates a method of implementing incremental graph view maintenance.

FIG. 3 illustrates an overview of a graphing environment.

FIG. 4 illustrates a computing system for implementing incremental graph view maintenance.

FIG. 5 illustrates an overview of implementing incremental graph view maintenance.

FIG. 6 illustrates a data system for dynamically modifying graph views based on changes in a relational database.

FIG. 7 illustrates an overview of providing graph view maintenance based on modifications to a relational database.

### DETAILED DESCRIPTION

Graph analytics is accomplished using one or more computing devices to organize and graph relational data. These computing devices may include server computers, desktop computers, laptop computers, or other similar computing devices. In operation, to apply graph analytics and generate initial graph views, data items are stored into formally described tables in what is known as a relational database. These data items may include transaction data, friendship data, and purchase data, among other data—including combinations thereof. Following the input of the data items, a graph or graph view may be generated based on the tables to better visualize and answer queries to the relational database. These graphs help in answering relationship queries such as shortest path or degrees of separation, but are limited to searching the data of the original tables. Accordingly, as data is added, deleted, or otherwise changed within the tables, the graph view may no longer accurately reflect the relational database.

To assist in updating the graph views in conjunction with the relational database, a graph maintenance module may be included within the data system. This graph maintenance module may be used to identify changes within the relational database, identify a graph view modification based on the change to the relational database, and implement the graph view modification in the graph view database. For example, if a data item were added to a table within the relational database, the graph maintenance module may identify this addition and, responsively, identify a change to one or more graph views within the graph database. Here, because an addition was made to the relational database, one or more nodes or edges may be generated to maintain the graph in conjunction with the relational database.

Similar to adding information to the relational database, a user or automated process may prefer to remove data items or relationships from the relational database. Responsively, the graph maintenance module may identify one or more edges or nodes to delete from the graph views, and implement the deletions within the graph views. Accordingly, as data items and relationships are removed from a relational database, the removals will also be maintained within the previously generated graph views.

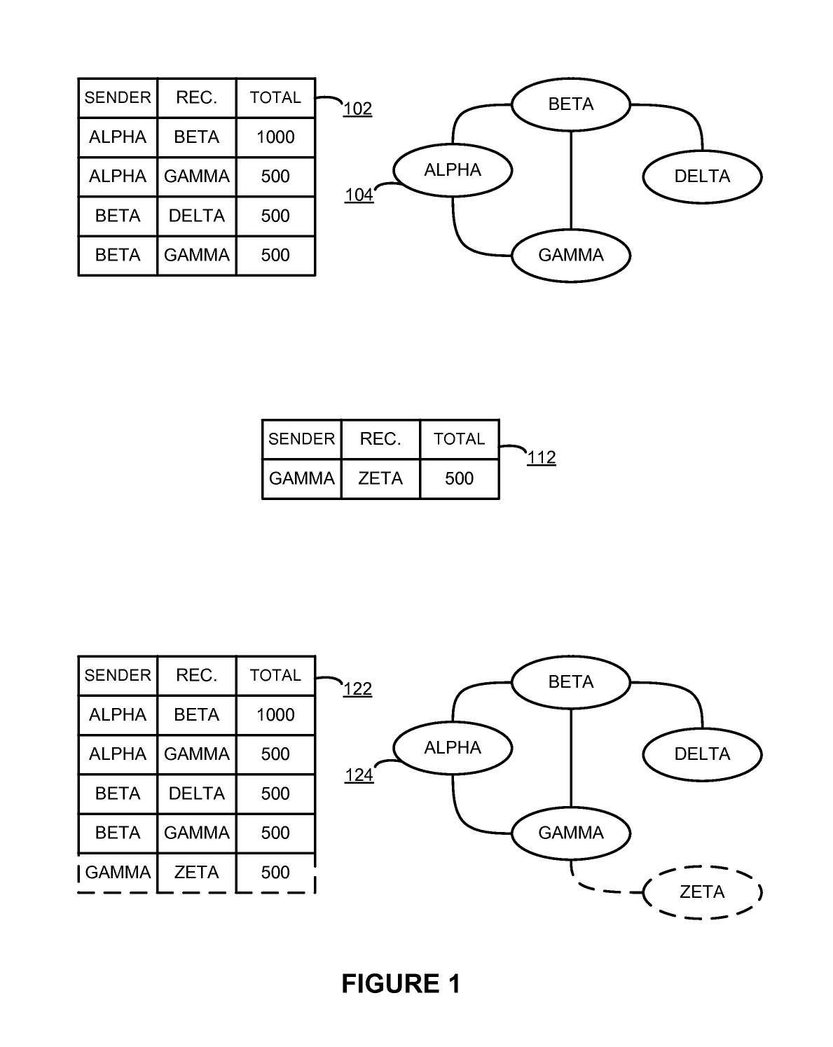

Turning to FIG. 1, FIG. 1 illustrates an overview of implementing graph view maintenance. FIG. 1 includes original table 102, original graph 104, data change 112, new table 122, and new graph 124. In operation, original table 102 may include a variety of data items such as, in the illustrated example, money transactions between persons. In turn, an original graph 104 may be generated to reflect the relationship of money changing hands between the different persons. This graph may make it easier both to visualize the transactions, as well as to answer queries regarding the transactions.

In the present instance, once original graph 104 is generated, data change 112 is added to the relational database and original table 102 to generate new table 122. During this change, a graph maintenance module, which may comprise a daemon, script, or other similar software, may be used to monitor for a modification being made to the relational database. Once a change is identified, such as data change 112, the module will identify the appropriate modification to original graph 104. Thus, both the graph view and the relational database may be updated with the changed data concurrently, resulting in new table 122 and new graph 124.

In an alternative example, rather than updating the graph view at the same time as the relational database, the daemon, script, or other software may monitor for changes to be applied within the relational database. By monitoring for changes in the relational database, a modification can first be made to the relational database, and then be reflected in the graph view of the database.

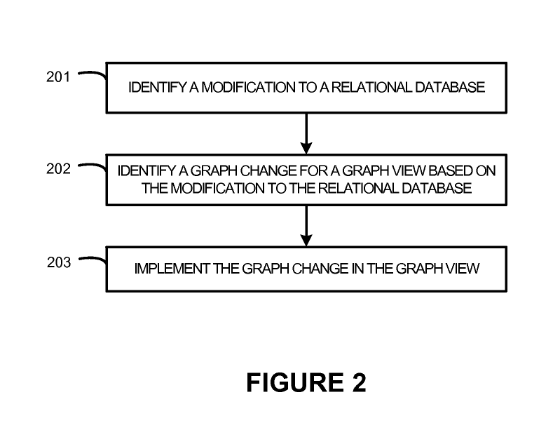

FIG. 2 illustrates a method of implementing incremental graph view maintenance for a graph view based on a relational database. The method identifies a modification to a relational database (201). In some examples, the identification can come as modification is entered, thus allowing both the graph view and the relational database to be updated simultaneously. In the alternative, the identification can come from monitoring the relational database itself. Hence, if a change is detected in the relational database, the change could be identified for graph view maintenance.

Following the identification of a relational database modification, the method provides identifying a graph change for a graph view based on the modification to the relational database (202). Using the example of FIG. 1, upon the addition of another transaction to the data table, represented by data change 112, a proper alteration to the graph view can be identified. There, the addition of the link between Gamma and Zeta, as illustrated in new graph 124. Once identified, the method provides implementing the graph change in the graph view (203).

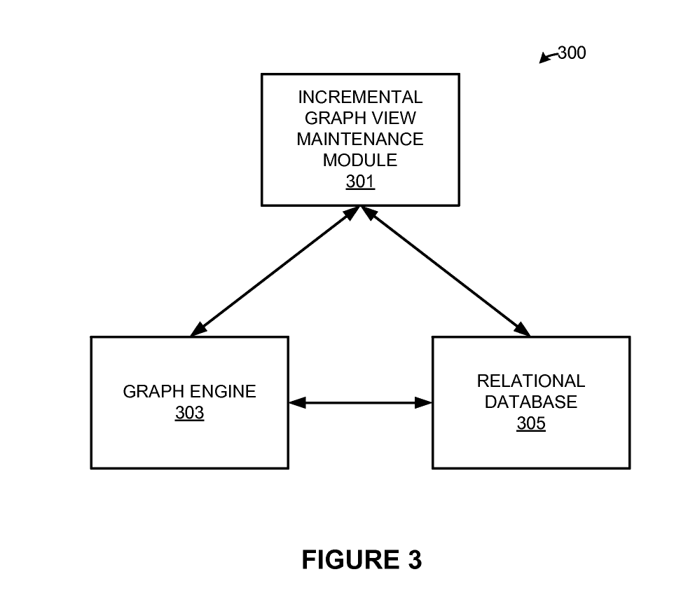

FIG. 3 illustrates an overview of a graphing environment 300. Graphing environment 300 includes incremental graph view maintenance module 301, graph engine 303, and relational database 305. In operation, module 301, graph engine 303, and relational database 305 may be implemented on one or more computing systems. Relational database 305 is a collection of data items organized as a set of formally described tables from which data and relationships can be accessed. Based on these data items, graph engine 303 may create a graph view to represent the data and to better respond to queries regarding the data and relationships. Incremental graph view maintenance module 301 will monitor for changes to the relational database, identify when these changes occur, identify a corresponding change to the appropriate graph view, and implement the change to the appropriate graph view.

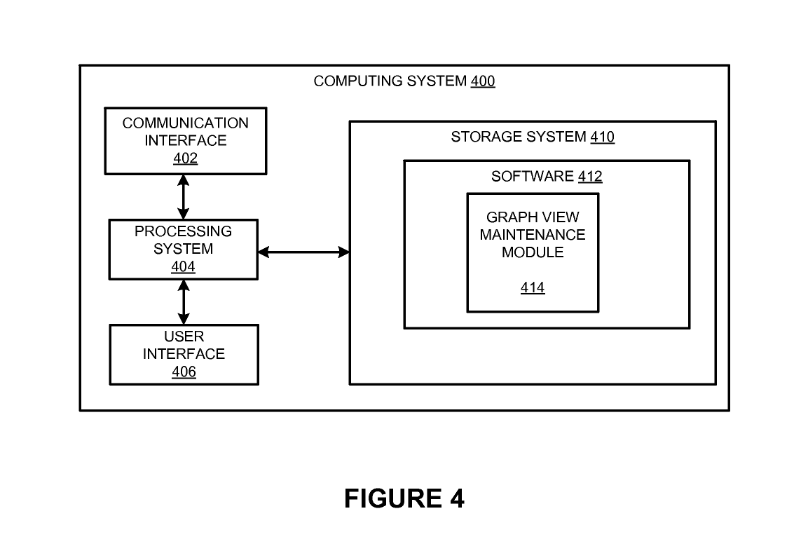

FIG. 4 illustrates a computing system 400 for implementing incremental graph view maintenance. Computing system 400 includes communication interface 402, processing system 404, user interface 406, storage system 410, and software 412. Processing system 404 loads and executes software 412 from storage system 410. Software 412 includes graph view maintenance module 414, which may be a daemon, a script, or some other similar form of software. Software 412 may further include an operating system, utilities, drivers, network interfaces, applications, or some other type of software. When executed by computing system 400, software module 414 directs processing system 404 to provide incremental graph view maintenance as described herein.

In a particular example, graph view maintenance module 414 will provide alterations to a graph view previously generated from a relational database. In operation, module 414 will identify a modification to the relational database, identify a graph change for the graph view based on the modification to the relational database, and implement the graph change in the graph view. The modification to the relational database may come from a human interface, may be automated, or may be entered by any other method. The modification may include, adding to the data in the tables, deleting data in the tables, changing preexisting data in the tables, or any other modification to the relational database.

Although computing system 400 includes one software module in the present example, it should be understood that any number of modules could provide the same operation.

Additionally, computing system 400 includes communication interface 402 that may be configured to interact with a relational database and a graph engine that generates the graphs. Communication interface 402 may communicate using Internet Protocol (IP), Ethernet, communication signaling, or any other communication format. Although not illustrated in the present example, it should be understood that the relational database and the graph engine might be implemented wholly or partially on computing system 400.

Referring still to FIG. 4, processing system 404 may comprise a microprocessor and other circuitry that retrieves and executes software 412 from storage system 410. Processing system 404 may be implemented within a single processing device, but may also be distributed across multiple processing devices or sub-systems that cooperate in executing program instructions. Examples of processing system 404 include general-purpose central processing units, application specific processors, and logic devices, as well as any other type of processing device, combinations of processing devices, or variations thereof.

Storage system 410 may comprise any storage media readable by processing system 404, and capable of storing software 412. Storage system 410 may include volatile and nonvolatile, removable and non-removable media implemented in any method or technology for storage of information, such as computer readable instructions, data structures, program modules, or other data. Storage system 410 may be implemented as a single storage device, but may also be implemented across multiple storage devices or sub-systems. Storage system 410 may comprise additional elements, such as a controller, capable of communicating with processing system 404.

Examples of storage media include random access memory, read only memory, magnetic disks, optical disks, flash memory, virtual memory, and non-virtual memory, magnetic cassettes, magnetic tape, magnetic disk storage or other magnetic storage devices, or any other medium which may be used to store the desired information and that may be accessed by an instruction execution system, as well as any combination or variation thereof, or any other type of storage media. In some implementations, the storage media may be a non-transitory storage media. In some implementations, at least a portion of the storage media may be transitory. It should be understood that in no case is the storage media a propagated signal.

User interface 406 may include a mouse, a keyboard, a camera, a voice input device, a touch input device for receiving a gesture from a user, a motion input device for detecting non-touch gestures and other motions by a user, and other comparable input devices and associated processing elements capable of receiving user input from a user. Output devices such as a graphical display, speakers, printer, haptic devices, and other types of output devices may also be included in user interface 406. In some examples, user interface 406 may be omitted.

It should be understood that although computing system 400 is illustrated as a single system for simplicity, the system might comprise one or more systems or devices.

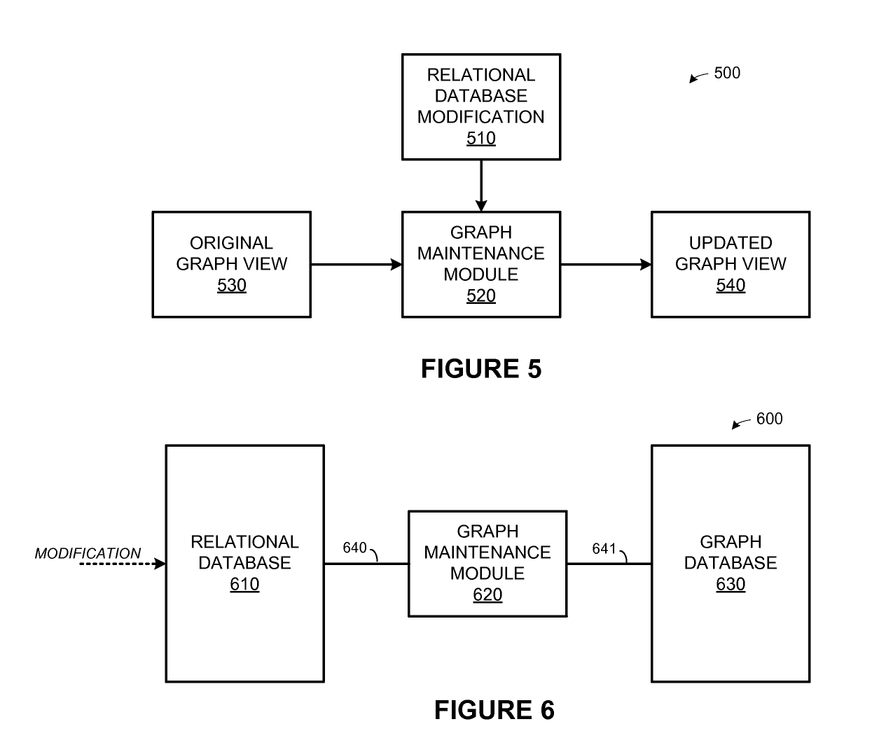

Referring now to FIG. 5, FIG. 5 illustrates an overview 500 of implementing incremental graph view maintenance according to one example. Overview 500 includes relational database modification 510, graph maintenance module 520, original graph view 530, and update graph view 540. Graph maintenance module 520 may reside on any computing device or system of devices capable of identifying a modification to a relational database and applying the modification to a graph view.

In operation, a data system or graph analytics system may include a relational database that organizes data items and relationships into one or more formally described tables, and may further include a graphing database that generates and stores graph views based on the data items and relationships stored within the relational database. The graph views include one or more nodes that are connected via edges to allow different visual interpretations of the data within the relational database, as well as allow faster traversals of the data to answer queries to the data. After the graphs are generated and stored within a storage repository, the original data in the relational database may be modified, thus, rendering the stored graph views obsolete. For example, if a graph view were generated for a social network to illustrate the friendships between groups of people, a new person being added to the relational database would render the previous graph obsolete.

To assist in dynamically modifying the graph views based on the relational database changes, graph maintenance module 520 is provided. As illustrated in FIG. 5, graph maintenance module 520 is configured to identify when relational database modification 510 occurs. Once the change or modification is identified, graph maintenance module 510 identifies original graph view 530 that relates to the data items changed within the relational database, and implements the changes within original graph view 530 to generate updated graph view 540.

In some examples, relational database modification 510 corresponds to an addition to the relational database. Thus, if a new user were added to a social network, a corresponding node and relationship edges may be added to a graph view in conjunction with the addition to the relational database. Similarly, relational database modification 410 may correspond to a deletion to the relational database. Accordingly, returning to the social network example, a user may be removed from a social network, causing the node representing the user and any corresponding edges to be removed from the graph. Further, relational database modification 510 may be used to update or modify data that has already been entered within the relational database. Again referring to the social network example, relational database modification may include modifying relationships between the end users, resulting in changes in the nodes and edges of the graph view.

Although illustrated in the present example with a single graph view being updated, it should be understood that any number of graph views might be updated based on a change within the relational database system. As a result, although one data item may be added, deleted, or modified within the relational database, the modification may be identified and applied to all graphs that concern that data item.

Turning to FIG. 6, FIG. 6 illustrates a data system 600 for dynamically modifying graph views based on changes in a relational database. Data system 600 includes relational database 610, graph maintenance module 620, and graph database 630. Although illustrated separate in the present example, it should be understood that graph maintenance module 620 might reside wholly or partially within relational database 610 and graph database 630. Relational database 610 communicates with graph maintenance module 620 over communication link 640. Graph maintenance module 620 further communicates with graph database 630 over communication link 641.

Relational database 610, graph maintenance module 620, and graph database 630 may each comprise a router, memory device, software, processing circuitry, cabling, power supply, network communication interface, structural support, or some other communication or computer apparatus. In some examples, relational database 610 and graph database 630 may comprise one or more computing devices capable of storing relational data and graph views that correspond to the relational data.

Communication links 640-641 each use metal, glass, optical, air, space, or some other material as the transport media. Communication links 640-641 may use Time Division Multiplex (TDM), asynchronous transfer mode (ATM), IP, Ethernet, synchronous optical networking (SONET), hybrid fiber-coax (HFC), circuit-switched, communication signaling, wireless communications, or some other communication format, including improvements thereof. Communication links 640-641 may each be a direct link, or can include intermediate networks, systems, or devices, and can include a logical network link transported over multiple physical links.

In operation, relational database 610 stores relational data items and relationships regarding the data items into one or more formally described tables. Once the data is stored within the tables, a graph engine, not pictured, may identify data within the tables and generate graphs to respond to user queries. These graphs may allow users to more easily visualize the data represented within the tables, as well as provide an easier method for traversing the data and responding to relational queries about the data. Once the graph views are generated for the relational data, users or automated processes may modify the data within the relational tables. As a result, although the original graphs may have reflected the proper data when generated, the graphs may no longer be valuable as the data is modified.

To accommodate this issue and dynamically adjust the graphs generated in graph database 630, graph maintenance module 620 is provided. Graph maintenance module 620 identifies when a modification is made to the rational database and carries the modifications to the corresponding graphs. For example, if a user or automated process adds a data object to relational database 610, graph maintenance module 620 will identify the modification, identify a graph modification based on the modification to the relational database, and apply the graph modification to the appropriate graph view. Using the current example, graph maintenance module 620 may add one or more nodes and edges to the appropriate graph to update the graph in accordance with the addition to the relational database.

Similar to the adding modification in a graph view, a user or other automated process may desire to remove or delete items from relational database 610. Responsive to this deletion, graph maintenance module 620 identifies the modification to the database, relates the deletion in the database to a change for one or more graph views in graph database 630, and applies the appropriate modification. For instance, to apply the appropriate modification in graph database 630, graph maintenance module 620 may delete one or more nodes and edges to provide updated graph views that appropriately relate to the deletion within the relational database.

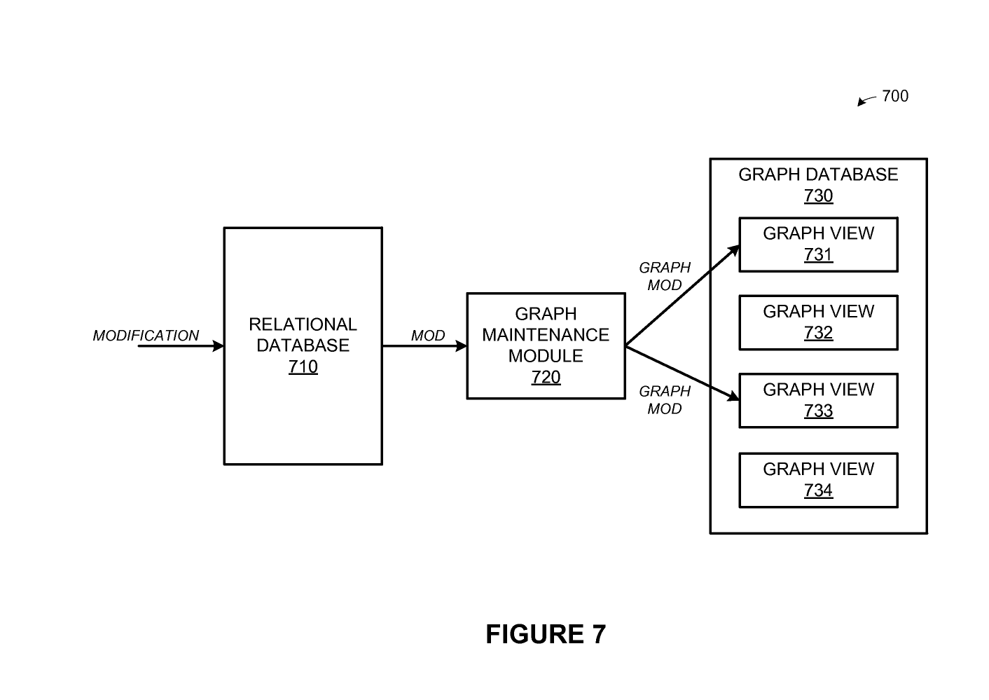

Turning now to FIG. 7, FIG. 7 illustrates an overview 700 of providing graph view maintenance based on modifications to a relational database. Overview 700 includes relational database 710, graph maintenance module 720, and graph database 730. Relational database 710 may include one or more formally described tables to store data items, such as social network information, financial information, or other various information objects. Graph database 730 stores graph views 731-734 based on the data in relational database 710. These graph views may be used to better illustrate and more easily traverse the data represented within relational database 710.

In operation, a user or automated process may generate graph views from the data stored within relational database 710. These graph views may include one or more nodes connected by edges to demonstrate the various connections and relationships between data items. For example, in the social network context, a graph view may be generated with persons as nodes, and friendships represented by the edges connecting the various nodes. Once generated, the graphs may then be used to answer various queries to the data, often faster than would be possible by using the relational database alone.

Although the graph views when generated may accurately reflect the data within relational database 710, relational database 710 may be constantly evolving. Accordingly, data items within relational database 710 may be modified, new items may be added, or previously included items may be deleted. Thus, as time progresses, the graphs may no longer accurately reflect the status of relational database 710.

To accommodate the changing graphs, graph maintenance module 720 is included to identify the changes within relational database 710 and carryout the changes within graph database 730. As illustrated in the present example, a modification to relational database 710 is identified by graph maintenance module 720. In response to this modification, graph maintenance module 720 identifies graph modifications for one or more graph views in graph database 730. Once the graph modifications are identified along with the appropriate graph views, graph maintenance module 720 may carry out the graph modifications in the appropriate graphs.

In some examples, the modification to relational database 710 includes an addition to the relation database, such as an added relationship or data item. Responsive to this addition, graph maintenance module identifies one or more nodes or edges to be added to graph views 731 and 733. Once identified, the graph views 731 and 733 may be updated to reflect the changes that were made in relational database 710.

Further, graph maintenance module 720 may identify deletions of data items and relationships within relational database 710. Responsive to the deletions, graph maintenance module may identify one or more nodes or edges to be removed from the graph based on the deletion within the graph database. For example, relational database 710 may be used to manage a social network and the friendships between various persons of the social network. As time progresses, the friendships between the various persons may change including adding new friendships, removing old friendships, adding new persons and relationships for that person, amongst other possible changes to the social network and relational database. As the changes are made within the relational database, graph maintenance module 720 may be used to monitor and identify as the changes take place. Accordingly, if a friendship were deleted between two persons of the social network, graph maintenance module may delete an edge in a graph view corresponding to the relational database.

Although illustrated in the previous examples as implementing the graph view changes in real time with the relational database changes, it should be understood that the updates to the graph views might occur in periodic intervals. Thus, the graph maintenance module may be configured to update the graphs every hour, day, or week based on the changes within the relational database.

The included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method of operating a graph maintenance module to implement graph view maintenance on a graph view, the method comprising:
identifying a modification to a relational database;
identifying a graph modification for the graph view based on the modification to the relational database; and
implementing the graph modification in the graph view.

2. The method of claim 1 wherein identifying the modification in the relational database comprises identifying an addition to the relational database.

3. The method of claim 2 wherein identifying the graph modification for the graph view based on the modification in the relational database comprises identifying at least one additional node or edge for the graph view based on the addition to the relational database.

4. The method of claim 3 wherein implementing the graph modification in the graph view comprises adding the at least one additional node or edge to the graph view.

5. The method of claim 1 wherein identifying the modification in the relational database comprises identifying a deletion to the relational database.

6. The method of claim 5 wherein identifying the graph modification for the graph view based on the modification in the relational database comprises identifying at least one node or edge for deletion in the graph view based on the deletion to the relational database.

7. The method of claim 6 wherein implementing the graph modification in the graph view comprises removing the at least one node or edge in the graph view.

8. The method of claim 1 wherein the graph view comprises one or more nodes and edges based on the relational database.

9. A computer apparatus to implement incremental graph view maintenance on a graph view, the computer apparatus comprising:
processing instructions that direct a computing system, when executed by the computing system, to:
identify a modification to a relational database;
identify a graph modification for the graph view based on the modification to the relational database; and
implement the graph modification in the graph view; and
one or more non-transitory computer readable media that store the processing instructions.

10. The computer apparatus of claim 9 wherein the processing instructions to identify the modification in the relational database direct the computing system to identify an addition to the relational database.

11. The computer apparatus of claim 10 wherein the processing instructions to identify the graph modification for the graph view based on the modification in the relational database direct the computing system to identify at least one additional node or edge for the graph view based on the addition to the relational database.

12. The computer apparatus of claim 11 wherein the processing instructions to implement the graph modification in the graph view direct the computing system to add the at least one additional node or edge to the graph view.

13. The computer apparatus of claim 9 wherein the processing instructions to identify the modification in the relational database direct the computing system to identify a deletion to the relational database.

14. The computer apparatus of claim 13 wherein the processing instructions to identify the graph modification for the graph view based on the modification in the relational database direct the computing system to identify at least one node or edge for deletion in the graph view based on the deletion in the relational database.

15. The computer apparatus of claim 14 wherein the processing instructions to implement the graph view modification in the graph view direct the computing system to remove the at least one node or edge in the graph view.

16. The computer apparatus of claim 9 wherein the graph view comprises one or more nodes and edges based on the relational database.

17. A data system comprising:
a relational database configured to store data and relationship information concerning the data;
a graph database configured to store one or more graph views related to the relational database; and
a graph maintenance module configured to:
identify a modification to the relational database;
identify a graph modification for at least one graph view in the graph database based on the modification to the relational database; and
implement the graph modification in the at least one graph view.

18. The data system of claim 17 wherein the modification to the relational database comprises an addition to the relational database.

19. The data system of claim 17 wherein the modification to the relational database comprises a deletion to the relational database.

20. The data system of claim 17 wherein the graph maintenance module configured to identify the modification to the relational database is configured to periodically identify a relational modification to the relational database.
